(19) United States
(12) Patent Application Publication
(10) Pub. No.: US 2018/0124673 A1
(43) Pub. Date: May 3, 2018

(54) Method of Operating Uplink Beacons to Support Inter-Frequency Mobility

(71) Applicant: Futurewei Technologies, Inc., Plano, TX (US)

(72) Inventors: Nathan Edward Tenny, Poway, CA (US); Kari Juhani Leppanen, Helsinki (FI); Hongcheng Zhuang, Shenzhen (CN); Kai Xu, Shenzhen (CN)

(21) Appl. No.: 15/477,422

(22) Filed: Apr. 3, 2017

Related U.S. Application Data
(60) Provisional application No. 62/416,534, filed on Nov. 2, 2016.

(51) Int. Cl. H04W 36/30; H04L 5/00; H04W 72/04; H04W 72/12; H04W 36/16

(52) U.S. Cl. CPC H04W 36/30; H04L 5/0048; H04W 36/165; H04W 72/1268; H04W 72/0453

(57) ABSTRACT

Methods and systems for operating uplink beacons to support inter-frequency mobility are provided. An embodiment method in a serving TRP for operating UL reference signals to support inter-frequency mobility includes receiving a first reference signal from a UE, the first reference signal transmitted on a serving TRP UL frequency. The method also includes configuring a transmission gap pattern to be used for sending a second reference signal on a non-serving TRP UL frequency, the non-serving TRP UL frequency being different from the serving TRP UL frequency, and the transmission gap pattern representing a set of time intervals during which the UE is not scheduled by the serving TRP UL frequency. Additionally, the method also includes sending a transmission gap pattern configuration, a second reference signal configuration, and a signaling criteria for determining when to send the second reference signal to the UE.

### CROSS-REFERENCE TO RELATED APPLICATIONS

This application claims the benefit of U.S. Provisional Application No. 62/416,534, filed on Nov. 2, 2016, which application is hereby incorporated herein by reference in its entirety.

### TECHNICAL FIELD

The present invention relates generally to a system and method for inter-frequency mobility in wireless networks, and, in particular embodiments, to a system and method for uplink beacons to support inter-frequency mobility in wireless networks.

### BACKGROUND

Mobility based on uplink (UL) tracking is under active consideration in 3GPP, especially for the case where the UE is active. The beacon from the UE is used to track and determine whether to handover the UE to a new transmit-receive point (TRP). However, currently, no methods exist for managing the handover using the UE's beacon when the servicing and potential TRPs utilize different frequencies.

### SUMMARY

According to one aspect of the present disclosure, there is provided a method in a serving transmit-receive point (TRP) for operating uplink (UL) reference signals to support inter-frequency mobility. The method includes receiving, at the serving TRP, a first reference signal from a user equipment (UE), the first reference signal transmitted on a serving TRP UL frequency. The method also includes configuring, by the serving TRP, a transmission gap pattern to be used for sending a second reference signal on a non-serving TRP UL frequency, the non-serving TRP UL frequency being different from the serving TRP UL frequency, and the transmission gap pattern representing a set of time intervals during which the UE is not scheduled by the serving TRP UL frequency. Additionally, the method also includes sending, by the serving TRP to the UE, a transmission gap pattern configuration, a second reference signal configuration, and one or more signaling criteria for determining when to send the second reference signal.

According to one aspect of the present disclosure, there is provided a method in a non-serving transmit-receive point (TRP) for operating uplink (UL) reference signals to support inter-frequency mobility. The method includes receiving, at the non-serving TRP, a transmission gap pattern from a serving TRP. The transmission gap pattern is to be used by the UE for sending a reference signal on a non-serving TRP UL frequency. Accordingly, the transmission gap pattern may be used by the non-serving TRP to determine when the UE is expected to send reference signals. The non-serving TRP UL frequency is different from a serving TRP UL frequency. The transmission gap pattern represents a set of time intervals during which the UE is not scheduled by the serving TRP UL frequency. The method also includes receiving, at the non-serving TRP, the reference signal from the UE during the transmission gap pattern. The method also includes measuring a parameter of the reference signal, the parameter measurement used to determine whether to handover the UE from the serving TRP to the non-serving TRP.

According to one aspect of the present disclosure, there is provided a method in a user equipment (UE) for operating uplink (UL) reference signals to support inter-frequency mobility. The method includes transmitting, by the UE, a first reference signal on a first frequency to a serving transmit-receive point (TRP). The method also includes receiving, at the UE, a transmission gap pattern configuration to be used for sending a second reference signal on a second frequency. The second frequency corresponds to an UL frequency of a non-serving TRP. The transmission gap pattern represents a set of time intervals during which the UE is not scheduled by the serving TRP. The first frequency is not equal to the second frequency. The method also includes transmitting, by the UE, the second reference signal on the second frequency to the non-serving TRP. The method also includes retuning, by the UE, a radio of the UE to the first frequency.

According to one aspect of the present disclosure, there is provided a network component for operating uplink (UL) reference signals to support inter-frequency mobility. The network component includes a processor and a computer readable storage medium storing programming for execution by the processor. The programming includes instructions for receiving a first reference signal from a user equipment (UE), the first reference signal transmitted on a serving TRP UL frequency. The programming also includes instructions for configuring a transmission gap pattern to be used for sending a second reference signal on a non-serving TRP UL frequency. The non-serving TRP UL frequency is different from the serving TRP UL frequency. The transmission gap pattern represents a set of time intervals during which the UE is not scheduled by the serving TRP UL frequency. The programming also includes instructions for sending a transmission gap pattern configuration and a second reference signal configuration to the UE.

According to one aspect of the present disclosure, there is provided a network component for operating uplink (UL) reference signals to support inter-frequency mobility. The network component includes a processor and a computer readable storage medium storing programming for execution by the processor. The programming including instructions for receiving a transmission gap pattern from a serving transmit-receive point (TRP), the transmission gap pattern to be used for sending a reference signal to a non-serving TRP on a non-serving TRP UL frequency. The non-serving TRP UL frequency is different from a serving TRP UL frequency. The transmission gap pattern represents a set of time intervals during which the user equipment (UE) is not scheduled by the serving TRP UL frequency. The programming also includes instructions for receiving the reference signal from the UE during the transmission gap pattern. The programming also includes instructions for measuring a parameter of the reference signal, the parameter measurement used to determine whether to handover the UE from the serving TRP to the non-serving TRP.

According to one aspect of the present disclosure, there is provided a user equipment (UE) for operating uplink (UL) reference signals to support inter-frequency mobility. The network component includes a processor and a computer readable storage medium storing programming for execution by the processor. The programming including instructions for transmitting, by the UE, a first reference signal on a first frequency to a serving transmit-receive point (TRP). The programming also includes instructions for receiving, at the UE, a transmission gap pattern configuration to be used for sending a second reference signal on a second frequency. The second frequency corresponds to an UL frequency of a non-serving TRP. The transmission gap pattern represents a set of time intervals during which the UE is not scheduled by the serving TRP. The first frequency is not equal to the second frequency. The programming also includes transmitting, by the UE, the second reference signal on the second frequency to the non-serving TRP. The programming also includes retuning, by the UE, a radio of the UE to the first frequency.

Optionally, in any of the preceding aspects, another implementation of the aspect provides that the method includes or the network component includes instructions to perform receiving measurement information from the non-serving TRP, the measurement information determined by the non-serving TRP according to the second reference signal received by the non-serving TRP from the UE; and sending a handover message to the non-serving TRP and a handover message to the UE when the serving TRP determines that threshold handover criteria have been satisfied according to the measurement information and a measurement of the first reference signal determined by the serving TRP.

Optionally, in any of the preceding aspects, another implementation of the aspect provides that the method includes or the network component includes instructions to perform receiving a handover message from the non-serving TRP when the non-serving TRP determines that criteria for handover of the UE from the serving TRP to the non-serving TRP have been satisfied.

Optionally, in any of the preceding aspects, another implementation of the aspect provides that the method includes or the network component includes instructions to perform coordinating with the non-serving TRP to determine the second reference signal configuration.

Optionally, in any of the preceding aspects, another implementation of the aspect provides that the method includes or the network component includes instructions to perform sending, by the serving TRP to the UE, one or more signaling criteria by which the UE determines when to send the second reference signal.

Optionally, in any of the preceding aspects, another implementation of the aspect provides that the configuring, by the serving TRP, the transmission gap pattern to be used for sending a second reference signal on a non-serving TRP UL frequency comprises configuring, by the serving TRP, a plurality of gap patterns to be used for sending a plurality of second reference signals on a plurality of non-serving TRP UL frequencies, wherein each of the plurality of second reference signals corresponding to a respective one of a plurality of non-serving TRPs, wherein each of the non-serving TRP UL frequencies is different from the serving TRP UL frequency, and where the transmission gap patterns represent time intervals during which the UE is not scheduled by the serving TRP UL frequency.

Optionally, in any of the preceding aspects, another implementation of the aspect provides that the sending further comprises sending, by the serving TRP, a plurality of transmission gap pattern configurations and a plurality of second reference signal configurations to the UE.

Optionally, in any of the preceding aspects, another implementation of the aspect provides that the method includes or the network component includes instructions to perform receiving measurement information from at least two of the plurality of non-serving TRPs, the measurement information determined by each of the at least two non-serving TRPs according to the a corresponding one of the plurality of second reference signals received by each of the at least two of the plurality of non-serving TRPs from the UE.

Optionally, in any of the preceding aspects, another implementation of the aspect provides that the method includes or the network component includes instructions to perform determining a selected non-serving TRP from the at least two of the plurality of non-serving TRPs according to threshold handover criteria.

Optionally, in any of the preceding aspects, another implementation of the aspect provides that the method includes or the network component includes instructions to perform sending a handover message to the selected non-serving TRP and a handover message to the UE when the serving TRP determines that the threshold handover criteria have been satisfied according to the measurement information and a measurement of the first reference signal determined by the serving TRP.

Optionally, in any of the preceding aspects, another implementation of the aspect provides that the method includes or the network component includes instructions to perform sending a handover message to the serving TRP when the non-serving TRP determines that criteria for handover of the UE from the serving TRP to the non-serving TRP have been satisfied according to the parameter measurement.

Optionally, in any of the preceding aspects, another implementation of the aspect provides that the method includes or the network component includes instructions to perform sending a handover message to the UE when the non-serving TRP determines that criteria for handover of the UE from the serving TRP to the non-serving TRP have been satisfied according to the parameter measurement.

Optionally, in any of the preceding aspects, another implementation of the aspect provides that the method includes or the network component includes instructions to perform receiving a handover message from the serving TRP.

Optionally, in any of the preceding aspects, another implementation of the aspect provides that the method includes or the network component includes instructions to perform sending configuration information to the UE to enable to the UE to communicate with the non-serving TRP, the non-serving TRP becoming the TRP serving the UE.

Optionally, in any of the preceding aspects, another implementation of the aspect provides that the method includes or the network component includes instructions to perform coordinating with the serving TRP to determine criteria for handover of the UE from the serving TRP to the non-serving TRP.

Optionally, in any of the preceding aspects, another implementation of the aspect provides that the method includes or the network component includes instructions to perform receiving, by the UE, second reference signal criteria from the serving TRP, the second reference signal criteria specifying conditions to be met before the UE transmits the second reference signal during the transmission gap pattern.

Optionally, in any of the preceding aspects, another implementation of the aspect provides that the method includes or the network component includes instructions to perform receiving, at the UE, a handover message.

Optionally, in any of the preceding aspects, another implementation of the aspect provides that the method includes or the network component includes instructions to perform performing, by the UE, a handover procedure to the second frequency.

An advantage of a preferred embodiment of the present disclosure is the ability to provide mobility between transmit-receive points using different frequencies.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a block diagram of an embodiment of a wireless network;

FIG. 2 shows a block diagram of an embodiment of a wireless system using a hypercell;

FIG. 3 is a flowchart of a prior art method for mobility transfer between different hypercells;

FIG. 4 is a flowchart of an embodiment method for using uplink beacons to support inter-frequency mobility;

FIG. 5 is a flowchart of an embodiment method for a forward handover based on the beacon measurements for inter-frequency mobility;

FIG. 6 is a flowchart of an embodiment method for a handover based on the beacon measurements for inter-frequency mobility with configuration of the transmission gap pattern in a UL based case;

FIG. 7 is a flowchart of an embodiment method for handover based on the beacon measurements for inter-frequency mobility with configuration of the transmission gap pattern in a DL based case;

FIG. 8 is a flowchart of an embodiment method for transmission gap configuration for handover based on the beacon measurements for inter-frequency mobility;

FIG. 9 is a flowchart of an embodiment method in a source TRP for inter-frequency mobility;

FIG. 10 is a flowchart of an embodiment method in a target TRP for inter-frequency mobility;

FIG. 11 is a flowchart of an embodiment method in a UE for inter-frequency mobility;

FIG. 12 is an embodiment method in a source TRP for inter-frequency mobility for selecting a target TRP from a plurality of potential target TRPs;

FIG. 13 is a flowchart of an embodiment method for in a UE for inter-frequency mobility to select from multiple target TRPs;

FIG. 14 illustrates a block diagram of an embodiment processing system for performing methods described herein, which may be installed in a host device;

FIG. 15 illustrates a block diagram of a transceiver adapted to transmit and receive signaling over a telecommunications network; and

FIG. 16 illustrates a network for communicating data.

### DETAILED DESCRIPTION OF ILLUSTRATIVE EMBODIMENTS

The making and using of the various embodiments are discussed in detail below. It should be appreciated, however, that the present disclosure provides many applicable inventive concepts that can be embodied in a wide variety of specific contexts. The specific embodiments discussed are merely illustrative of specific ways to make and use the invention, and do not limit the scope of the invention.

Disclosed herein are methods and systems for UL beacon based inter-frequency mobility for a user equipment (UE). In an embodiment, a transmission gap pattern is configured to be used for sending reference signals (e.g., beacons) on a non-serving target frequency. The transmission gap pattern represents time intervals during which the UE will not be scheduled by a serving frequency. The UE transmits beacons to the serving (i.e., source) transmit-receive point (TRP) (e.g., a gNode B (gNB)). The source TRP sends the transmission gap pattern, the beacon configuration information for transmitting beacons to the non-serving (i.e., target) TRP on the frequency used by the target TRP, which is different from the frequency used by the source TRP. When the criteria specified for sending beacons to the target TRP on the target TRPs frequency are satisfied, the UE will retune its radio from the frequency used by the source TRP to the frequency used by the target (i.e., neighbor) TRP and transmit beacons on the new frequency to the target TRP during the gap pattern. The target and source gNB will coordinate with each other such that one of them will make a handover decision based on the beacon measurement information that each TRP obtains and on implementation dependent criteria for making a handover. If a handover is determined, the TRP making the determination will transmit the handover indication to the other TRP and to the UE, after which, the UE will begin communicating with the target TRP (which will then become the serving TRP).

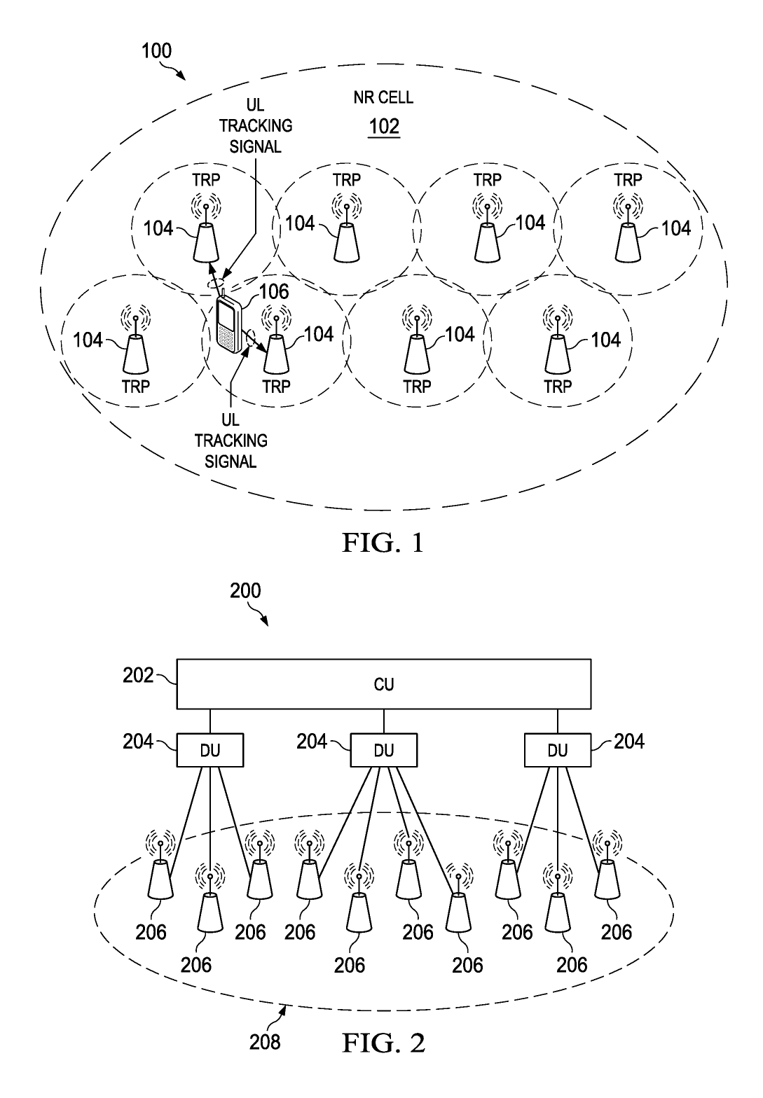

FIG. 1 shows a block diagram of an embodiment of a wireless network 100. The wireless network 100 includes a 5th generation mobile networks (5G) new radio (NR) cell 102. The NR cell 100 includes a plurality of transmit-receive points (TRPs) 104 and a user equipment (UE) 106. The UE 106 is capable of transmitting and receiving on multiple frequencies. The UE 106, moving through the wireless network 100, transmits periodic uplink (UL) beacon transmissions. In an embodiment, the beacon is a narrow band and short duration and, thus, transmission is power efficient. The beacon configuration is provided by the network 100 and is UE-specific. The beacon may include a sequence based on a UE identifier (ID) or otherwise assigned to the UE 106. The network 100 monitors the beacon and uses it to track the UE 106. Basic radio information provides the network with which TRP(s) 104 have the best coverage towards the UE 106. Enhancements, such as geolocation based on the beacon transmission, can be implemented in the network 100 transparently to the UE 106.

Mobility with beacons relies on the serving (“source”) and neighbor (“target”) TRPs 104 being able to detect the beacon at substantially the same time. The UE's beacon configuration is provided to the target TRP 104, which can then monitor the beacon transmissions in the same way as the source TRP 104 does. A mobility decision (i.e., determining whether to hand the UE off to the target TRP) is then based on comparing the UL sounding results for the beacon at the two TRPs 104. The details of the criteria for making the mobility decision are configured by the network 100 and are implementation dependent. An example criterion is a threshold beyond which a handover takes place. The entire process is transparent to the UE 106 (at least at layer 3). The UE 106 simply keeps transmitting the beacon.

This coordination of TRPs 104 leads naturally to a “hypercell” concept in which multiple TRPs 104 coordinate to appear as a single “cell” like object. FIG. 2 shows a block diagram of an embodiment of a wireless system 200 using a hypercell 208. The wireless system includes a central unit (CU) 202, a plurality of distributed units (DUs) 204, and a plurality of TRPs 206. The TRPs 206 provide wireless access to UEs (not shown) in a coverage area 208. The hypercell 208 includes a single CU 202 with a plurality of DUs 204 coordinated underneath the single CU 202. Each DU may control one or more TRPs 206.

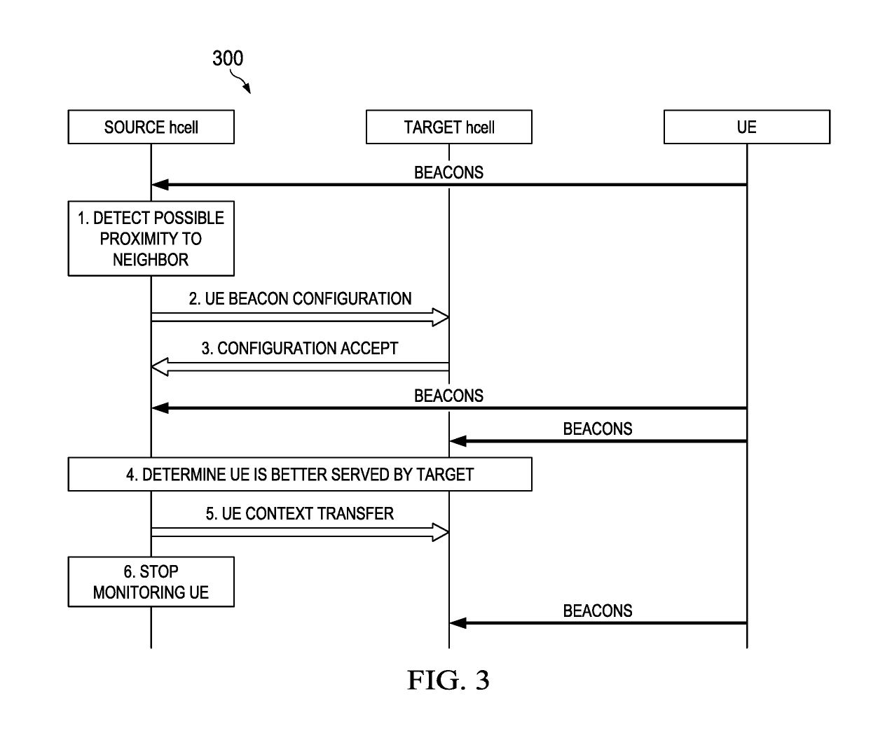

FIG. 3 is a flowchart of a prior art method 300 for mobility transfer between different hypercells. The UE sends beacons which the source hypercell (hcell) monitors. At block 1, the source cell determines that UE may possibly be proximate to a neighbor (i.e., target hcell) and, at block 2, sends UE beacon configuration to the target hcell. At block 3, the target cell sends a configuration accept message to the source hcell and begins monitoring the beacons from the UE. At block 4, either the source hcell or the target hcell determines that the UE is better served by the target hcell. At block 5, the source hcell sends a UE context transfer to the target hcell and, at block 6, the source hcell stops monitoring the UE. The target hcell continues monitoring the beacons from the UE and provides wireless service to the UE.

One problem with the method 300 is that it cannot be used for inter-frequency mobility. The basic problem is that, in some embodiments, the source hypercell utilizes frequency A and the target inter-frequency hypercell utilizes frequency B and thus, cannot receive the beacon on frequency A. This applies whenever the beacon frequency is not used by the target hypercell, e.g., there could be multiple frequency hypercells that overlap, but if a UE is using a beacon frequency not used in the target hypercell, the handover is, by definition, “inter-frequency.” However, mobility between frequencies is important for load balancing as well as dealing with local variations in frequency quality (e.g., frequency specific fading or interference). It is clearly necessary for NR to support inter-frequency handover.

Disclosed herein are methods and systems for using the beacon mechanisms for inter-frequency mobility. Note that these inter-frequency cases may be intra- or inter-band, intra- or inter-PLMN (Public Land Mobile Networks), etc. There are various use cases, but the mechanism is the same for all of these different cases. The disclosed systems and methods may be implemented when the two frequencies use the same radio front end in the UE, e.g., intra-band. However, the disclosed systems and methods may also be implemented when the UE uses a target frequency radio to transmit a beacon on that frequency without affecting its operations on the source frequency radio.

One may ask why the UE transmitter may not just be returned to frequency B while the UE receiver continues to monitor frequency A. In the time division duplex (TDD) case, there is no guarantee that the UL/down link (DL) patterns are aligned. Thus, the UL transmission opportunities on B may collide with the DL reception occasions on A. In the frequency division duplex (FDD) case, if the duplex is fixed, there is no guarantee that the transmitter (Tx) front end can tune to B while keeping the receiver (Rx) front end tuned on A. Even if the UE can transmit on B while receiving on A, there can be conflicts between when the UE needs to send a beacon and when the UE needs to make other transmissions, e.g., acknowledgements (ACKs). Finally, the serving cell is expecting to receive beacons to know that the UE remains in coverage. The UE cannot easily transmit beacons on A and B at the same time. Therefore, merely retuning the UE transmitter to frequency B is not realistic or workable.

Disclosed herein are methods and systems in which beacons on the target frequency are enabled by a transmission gap pattern. The network configures the UE with the gap pattern, target frequency, and triggering criteria. During the gaps, the UE tunes to the target frequency and sends beacons there. Transmission may be periodic or aperiodic according to the transmission gap pattern. The gap pattern is not necessarily the same as the transmission pattern on the source frequency. The gap pattern and the beacon configuration for the target frequency may be negotiated between the source and target g node Bs (gNBs). Candidate gNB(s) of the target frequency are informed of the UE's gap pattern and beacon configuration. The candidate gNB(s) (i.e., the target gNB(s)) take measurements as if they were serving the UE. The measurement results may be returned to the source gNB or may be processed internally in the target gNB. Handover may be triggered “backward” (i.e., the command is sent to the UE from the source gNB after the measurements) or “forward” (i.e., the command is sent to the UE from the target gNB during the transmission gap). The choice of handover mode (i.e., backward handover mode or forward handover mode) determines where the measurements should be processed. For backward handover, the source gNB decides whether a handover is made. Thus, the measurements from the target or sent to the source for decision making. For forward handover, the target gNB decides whether a handover is made. Thus, the measurements from the source gNB may be sent to the target gNB for the target gNB to process.

In an embodiment, when the UE is served by a hypercell on one frequency, it is triggered to sound on a different frequency based on threshold criteria. The gNB configures the UE with a transmission gap pattern. During a gap, the gNB “commits” not to schedule the UE for data in a manner similar to how measurement gaps work in LTE. The UE tunes its transmitter to the target frequency and sends beacons on the target frequency during the gap. After the gap, the UE returns to the source frequency (absent any instruction otherwise). In an embodiment, activation of the gap is based on criteria set by the network. Examples of criteria for activation of the gap include a threshold of serving signal strength, below which inter-frequency measurements will be taken. The activation of the gap is similar to s-Measure or Sintrasearch in LTE/UMTS, but triggers transmission of sounding beacons rather than measurement procedures by the UE. In an embodiment, the network may issue a command: “go send beacons now” to activate the gap and UE transmission on the target frequency during the gap.

In the methods described below and the corresponding figures, various steps or shown in an exemplary order. However, those of ordinary skill in the art will recognize that many of these steps may be performed in different orders and the present disclosure is not limited to the ordering of steps shown and described below. Also, although described primarily with reference to gNBs, it will be appreciated that the systems and methods described herein may be applied to other types of TRPs and are not limited to gNBs. It should also be noted that the terms “source” and “serving” are used interchangeably throughout this disclosure. Also, the terms “target”, “neighbor”, and “non-serving” are used interchangeably throughout this disclosure.

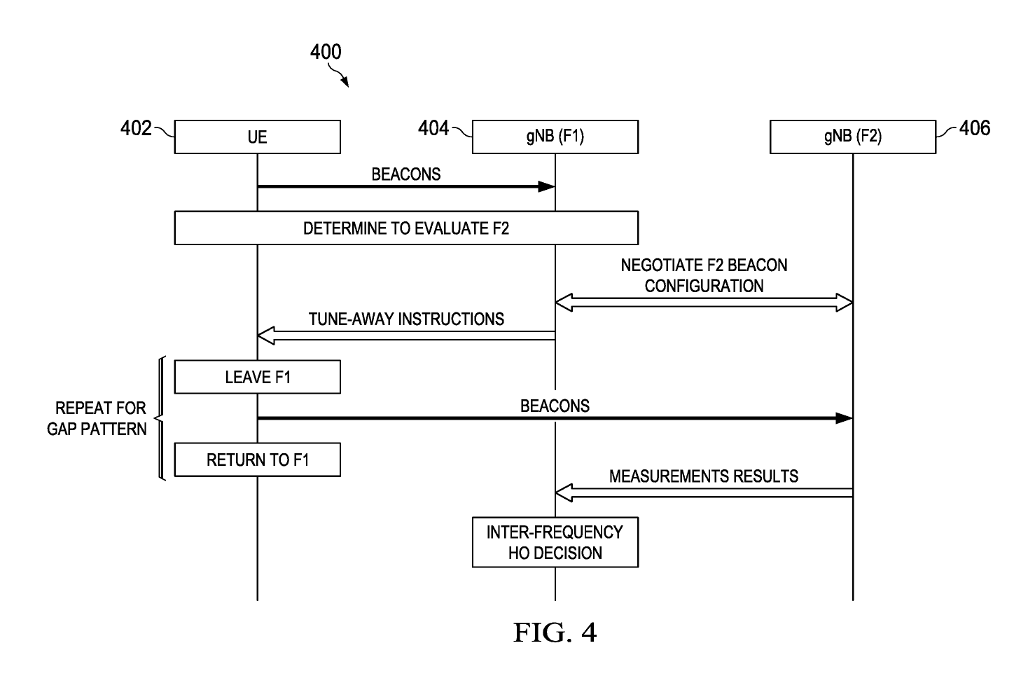

FIG. 4 is a flowchart of an embodiment method 400 for using uplink beacons to support inter-frequency mobility. The UE 402 sends beacons to the source gNB 404 on frequency F1. The network determines to evaluate frequency F2 on target gNB 406. The source gNB 404 and the target gNB 406 negotiate an F2 beacon configuration. The source gNB 404 sends tune-away instructions to the UE 402 instructing the UE 402 to leave F1 and tune to F2. The UE 402 leaves F1 and tunes to F2 and sends beacons on F2 during the gap period, after which, the UE 402 returns to F1 and sends beacons on F1. The procedure to leave F1, tune to F2, transmit beacons on F2, and return to F1 may be repeated several times. The number of times to repeat may be implementation dependent. In some embodiments, the procedure is not repeated. The target gNB 406 makes measurements based on the beacon transmitted on F2 by the UE 402 and sends the measurement results to the source gNB 404. The source gNB 404 makes a handover decision based on the measurement.

The threshold criteria in the step labeled “determining to evaluate F2” may be UL based, DL based, or a combination of the two. In an UL case (NW implementation), the criteria may be an implementation defined threshold for the measured UL quality. In the DL based case (UE specified behavior), the threshold criteria may be applied to a measured downlink signal such as CSI-RS or sync. In an embodiment, triggering the transmission gap is a network decision (explicit or implicit). The network may take into account UL measurements from the UE as well as information reported by the UE about its DL. In the DL-based case, the network is responsible to configure the UE's applied thresholds.

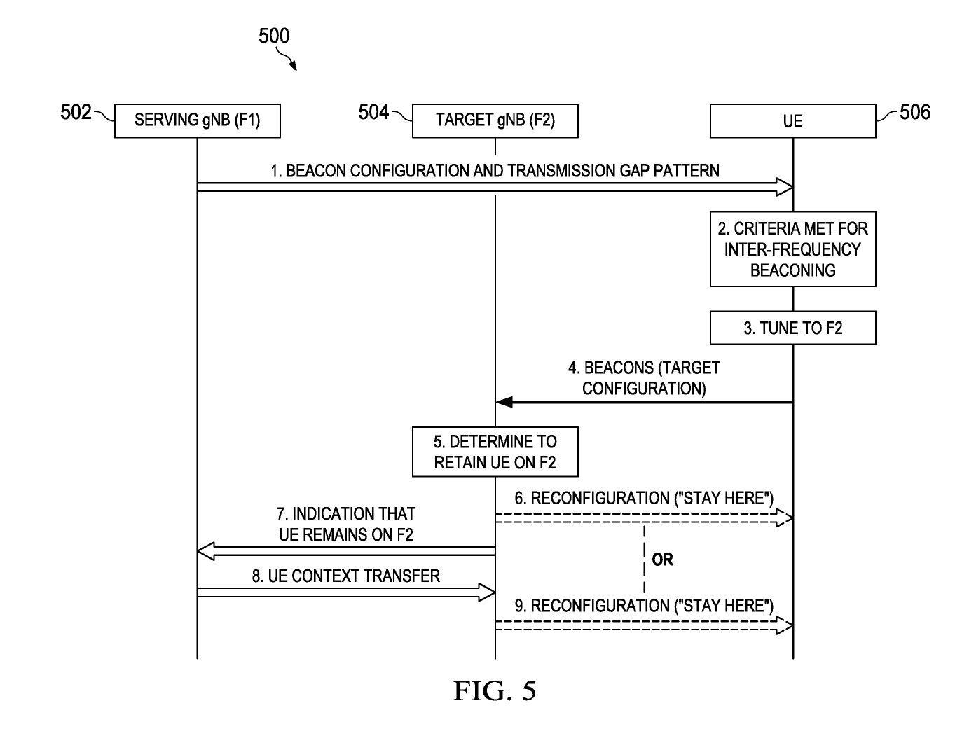

FIG. 5 is a flowchart of an embodiment method 500 for a forward handover based on the beacon measurements for inter-frequency mobility. In method 500, at block 1, the serving gNB 502 sends the beacon configuration and the transmission gap pattern to the UE 506. At block 2, the UE 506 determines whether the criteria for inter-frequency beaconing have been met. At block 3, if the criteria have been met, the UE 506 tunes its radio to frequency F2 (corresponding to the frequency for the target gNB 504). At block 4, the UE 506 sends a beacon on F2 to the target gNB 504. At block 5, the target gNB determines whether to retain the UE 506 on F2. At block 6, the target gNB 504 sends a reconfiguration “stay here” message to the UE 506 indicating that the UE 506 should begin communicating with the target gNB 504 on frequency F2. At block 7, the target gNB 504 sends an indication to the serving gNB 502 indicating that the UE 506 will remain on F2 and be served by the target gNB 504. At block 8, the serving gNB 502 sends a UE context transfer to the target gNB 504. In an alternative embodiment, at block 9, rather than sending the reconfiguration message at block 6, the target gNB 504 sends the reconfiguration message to the UE 506 after receiving the UE context transfer message from the serving gNB 502.

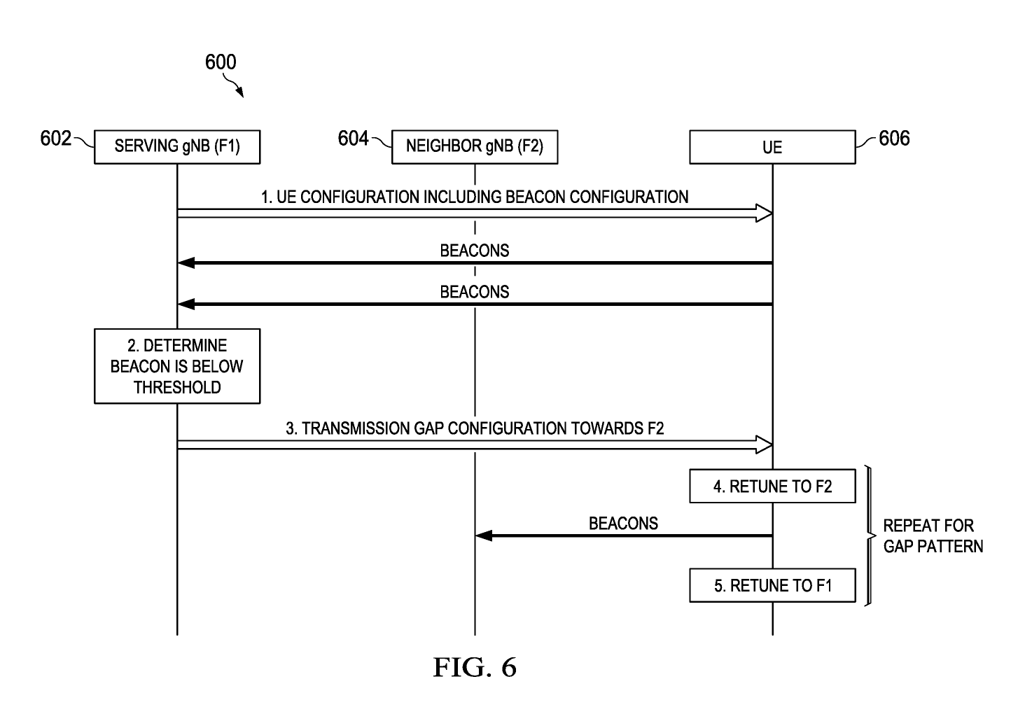

FIG. 6 is a flowchart of an embodiment method 600 for a handover based on the beacon measurements for inter-frequency mobility with configuration of the transmission gap pattern in a UL based case. In method 600, at block 1, the serving gNB (operating on frequency F1) sends UE configuration information which includes beacon configuration information to the UE 606. The UE 606 transmits beacons on frequency F1 to the serving gNB 602. At block 2, the serving gNB 602 determines whether the beacon is below a threshold. At block 3, the serving gNB 602 sends transmission gap configuration information for frequency F2 to the UE 606. At block 4, the UE 606 retunes to frequency F2 and sends a beacon on frequency F2 to the target gNB (i.e., the neighbor gNB). At block 5, the UE 606 retunes to F1. Block 4 and 5 may be repeated for the gap pattern. It should be noted that the “beacon below threshold” is merely an example. Other criteria could be considered in other embodiments. For example, other criteria may include the UE's approximate position, tracking loop for UE specific reference signals, etc. These criteria may also help to choose one or more target neighbors to prepare.

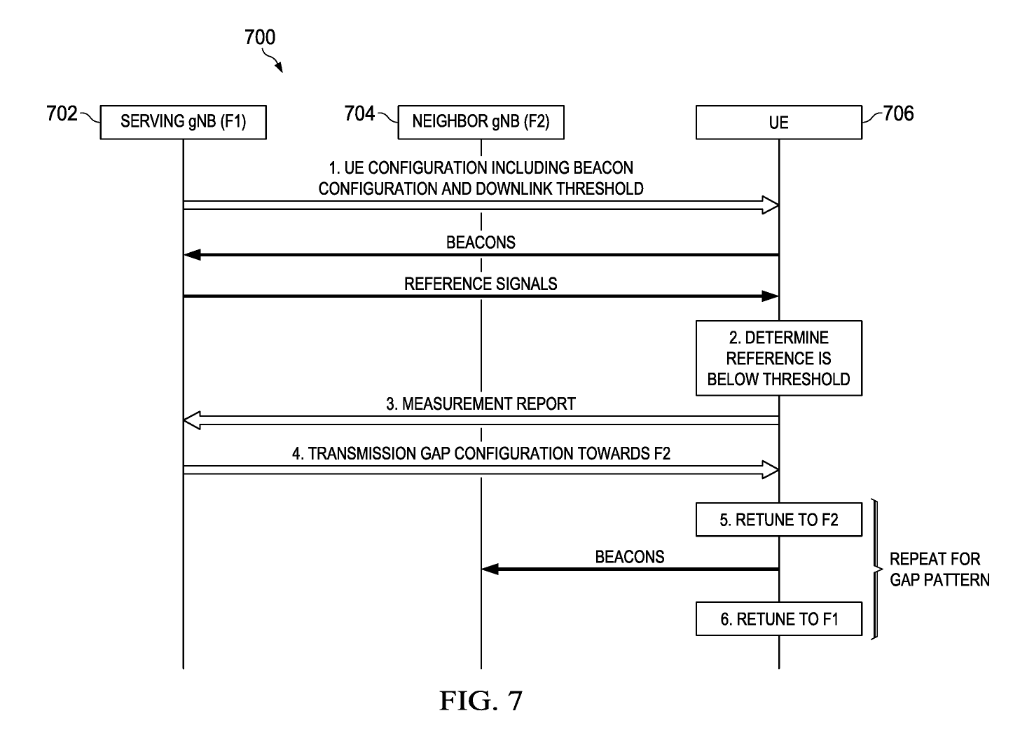

FIG. 7 is a flowchart of an embodiment method 700 for handover based on the beacon measurements for inter-frequency mobility with configuration of the transmission gap pattern in a DL based case. In method 700, at block 1, the serving gNB (operating in frequency F1) sends UE configuration including beacon configuration and a downlink threshold to the UE 706. The UE 706 then transmits beacons in frequency F1 to the serving gNB 702 and the serving gNB 702 transmits reference signals to the UE 706. At block 2, the UE 706 determines if the reference signal is below a threshold. At block 3, the UE 706 sends a measurement report to the serving gNB 702. At block 4, the serving gNB 702 sends a transmission gap configuration for frequency F2 to the UE 706. At block 5, the UE 706 retunes to frequency F2 and sends beacons on frequency F2 to the target gNB 704 (i.e., the neighbor gNB). At block 6, the UE retunes back to frequency F1 for communication with the serving gNB 702. The blocks 5 and 6 may be repeated for the gap pattern. In an embodiment, the “reference signals” may be CSI-RS, enhanced sync, etc. In the embodiment depicted in FIG. 7, direct network triggering is shown in block 4 where the UE is instructed to apply the gap pattern immediately.

The sounding process results in coordination between the serving and target (i.e., neighbor) (inter-frequency) gNBs. The target gNB reports its UL measurement results allowing the serving gNB to decide whether to trigger a handover when the UE returns. Alternatively, the serving gNB may configure the neighbor with a threshold above which the target gNB should “keep” the UE. In this case, the target gNB sends a command directly to the UE. This implies that the UE must be monitoring scheduling on the target gNB and the UE's ID must be known to the target gNB. It should also be noted that the target gNB may decide autonomously to “keep” the UE based on the beacon. In this case, the previously serving gNB should be notified. This is a pure forward handover.

Reconfiguration of the UE's beacon may happen after the handover. This determination is up to the target gNB implementation and would be an ordinary reconfiguration.

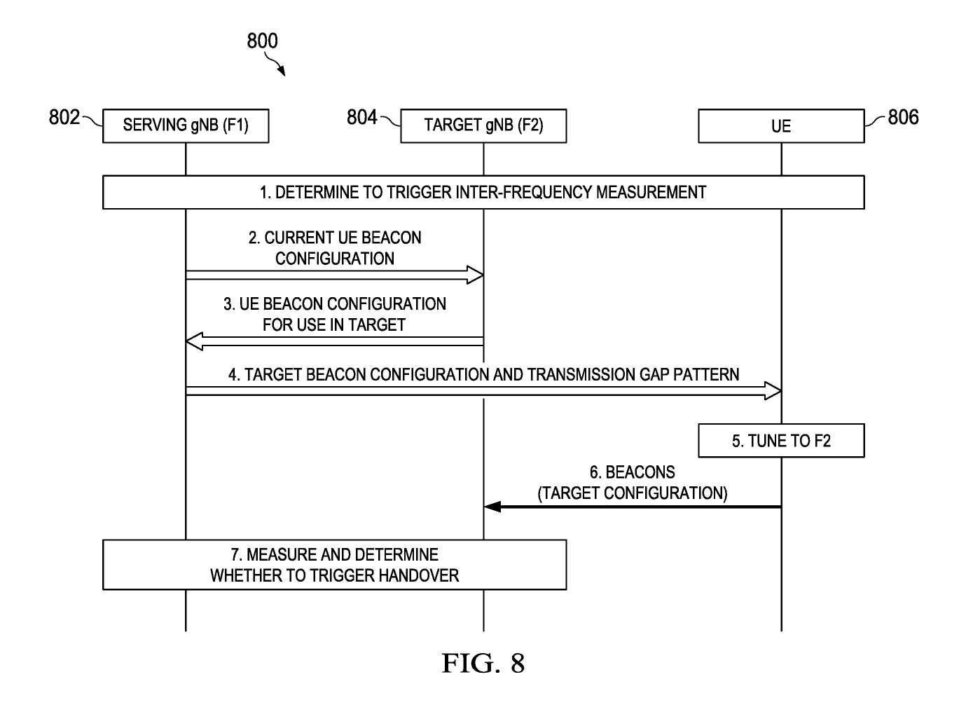

FIG. 8 is a flowchart of an embodiment method 800 for transmission gap configuration for handover based on the beacon measurements for inter-frequency mobility. The transmission gap configuration may be an aspect of a more general reconfiguration message. For example, as a result of pre-coordination with the target gNB, the serving gNB may assign the UE a new beacon configuration for use on the target gNB. Such a new configuration may be temporary (i.e., for use only during the transmission gap, discarded upon return) or may be persistent (i.e., it still applies even after the return). In method 800, at block 1, the serving gNB 802 (which operates on frequency F1) determines to trigger inter-frequency measurement. At block 802, the serving gNB 802 sends current UE beacon configuration information to the target gNB 804 (which operates on frequency F2). At block 3, the target gNB 804 sends UE beacon configuration for use in the target gNB 804 to the serving gNB 802. At block 4, the serving gNB 802 sends the target beacon configuration and transmission gap pattern to the UE 806. At block 5, the UE 806 tunes to the frequency F2. At block 6, the UE 806 sends beacons using the target gNB configuration to the target gNB 804. At block 7, the target gNB 804 measures the beacon and determines whether to trigger handover.

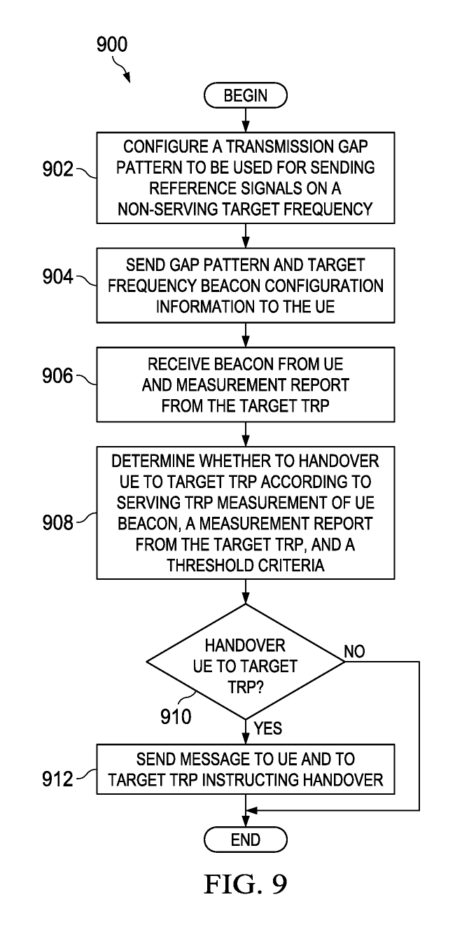

FIG. 9 is a flowchart of an embodiment method 900 in a source TRP for inter-frequency mobility. The method 900 begins at block 902 where the source TRP configures a transmission gap pattern to be used for sending reference signals on a non-serving target frequency. The transmission gap pattern represents time intervals during which the UE will not be scheduled by a serving frequency. At block 904, the source TRP sends the gap pattern and target beacon configuration information to the UE. The target beacon configuration information may include criteria for when the UE is to begin transmitting a beacon on the non-serving target frequency. The source TRP may also send the gap pattern and criteria for when the UE is to begin transmitting the beacon to the non-serving target TRP. However, this information may be negotiated between the source and target TRP in advance. At block 906, the source TRP receives a beacon from the UE and a measurement report from the target TRP. In an embodiment, the measurement report from the target TRP is based on the beacon the target TRP received from the UE on the target TRP's UL frequency during the transmission gap pattern. At block 908, the source TRP determines whether to handover the UE to the target TRP according to the source TRP measurement of the UE beacon on the source TRP's UL frequency, according to the measurement report from the target, and on one or more threshold criteria. Alternatively, the target TRP may determine whether to perform a handover and signal the determination to the source TRP. At block 910, the source TRP determines whether a handover of the UE to the target TRP has been indicated. If, at block 910, a handover is indicated, then, at block 912, the source TRP sends a message to the UE and to the target TRP instructing handover, after which, the method 900 may end. Alternatively, the source TRP may be signaled by the target TRP that a handover has been determined and the target TRP will signal to the UE to begin communicating with the target TRP on the target TRP's UL frequency.

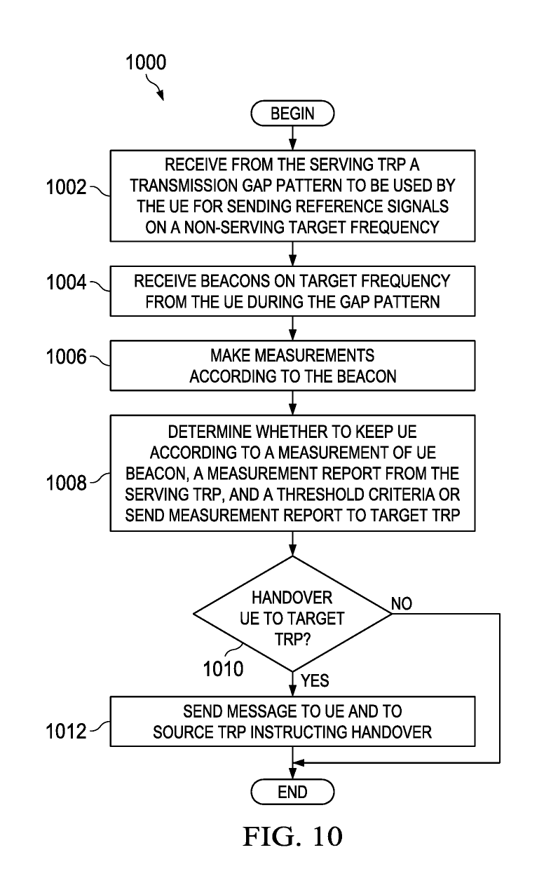

FIG. 10 is a flowchart of an embodiment method 1000 in a target TRP for inter-frequency mobility. The method 1000 may begin at block 1002 where the target TRP receives from the source TRP a transmission gap pattern to be used by the UE for sending reference signals on the non-serving target frequency. At block 1004, the target TRP receives beacons on the target frequency from the UE during the gap pattern. At block 1006, the target TRP makes measurements according to the beacon. At block 1008, the target TRP determines whether to keep the UE according to a measurement of the UE beacon in the target TRP's UL frequency, according to a measurement report from the source TRP, and one or more threshold criteria if the target TRP is making the handover determination and sends a measurement report to the source TRP if the source TRP is making the handover decision. At block 1010, the target TRP determines whether a handover of the UE from the source to the target has been made and, if yes, the method 1000 proceeds to block 1012 where the target TRP sends a message to the UE and to the source TRP instructing handover if the handover decision is made by the target TRP, after which, the method 1000 may end.

The criteria for determining whether to handover may be provided to the target TRP by the source TRP or from the network. Alternatively, the target TRP may send the criteria for determining whether to perform a handover to the source TRP. In some embodiments, the target TRP may autonomously determine to keep the UE based on its own criteria even when the criteria specified by the source TRP or the network have not been satisfied. The criteria for determining whether to handover the UE may be made on a UE by UE basis and may change dynamically as conditions within the network, the source TRP, and/or the target TRP change. In an embodiment, there may be multiple target TRPs identified and each target TRP may make its own measurement of the UE beacon. In an embodiment, the frequency of each target TRP may be different from other target TRPs and there may be a transmission gap pattern specified for each target TRP.

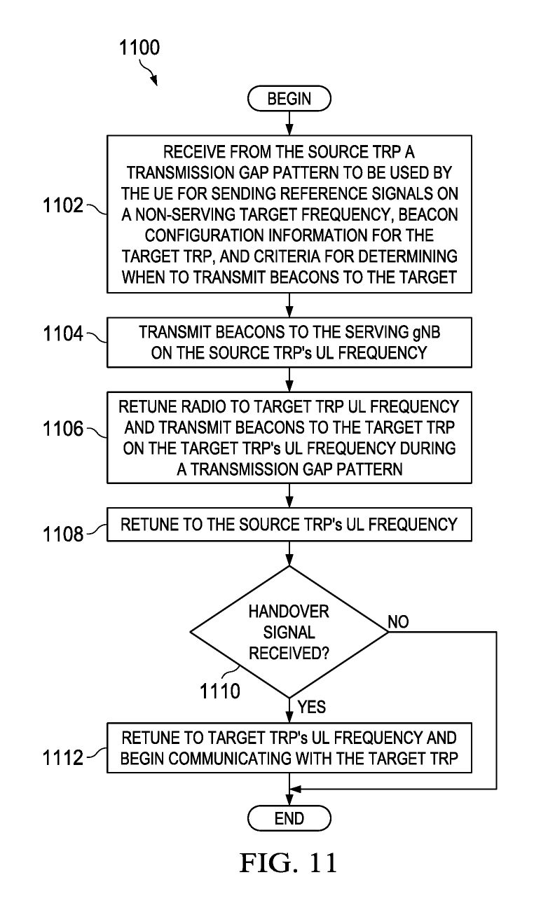

FIG. 11 is a flowchart of an embodiment method 1100 in a UE for inter-frequency mobility. The method 1100 may begin at block 1102 where the UE receives from the source TRP a transmission gap pattern to be used by the UE for sending reference signals on a non-serving target TRP's UL frequency, beacon configuration information for the target TRP, and criteria for determining when to transmit beacons to the target TRP on the non-serving target TRP's UL frequency. At block 1104, the UE transmits the beacons to the source (i.e., serving) TRP on the source TRP's UL frequency. At block 1106, the UE retunes its radio to the target TRP's UL frequency and transmits beacons to the target TRP on the target TRP's UL frequency during the transmission gap pattern when the criteria for doing so have been satisfied. At block 1108, the UE retunes to the source TRP's UL frequency. At block 1110, the UE determines if it has received a handover message from either the source TRP or the target TRP and, if yes, then the method 1100 proceeds to block 1112 where the UE retunes its radio to the target TRP's UL frequency and begins communicating with the target TRP on the target TRP's UL frequency, after which, the method 1100 may end.

In some embodiments, the serving TRP selects from one a plurality of targets to handover the UE. The serving TRP configures a transmission gap pattern for each of the targets and informs each target when it should expect to receive a beacon from the UE on that targets UL frequency. Each target TRP need only be made aware of the gap pattern in which the UE will transmit on its frequency. The UE is informed of the gap pattern for each target TRP and the UL frequency for each target TRP and transmits a beacon on the respective one of the target TRPs during the gap pattern assigned to that target TRP by the serving TRP. If two or more target TRPs use the same UL frequency, both (or all) of the TRPs may make a measurement of the UEs transmitted beacon during the same gap pattern. In an embodiment, the UE is capable of transmitting on more than one frequency simultaneously. For example, the UE may include multiple RF chains (e.g., because of MIMO or support of multiple bands with their own RF support) that can be individually configured. In such cases, the UE may transmit multiple UL reference signals simultaneously to a plurality of TRPs. Based on the measurement reports from the target TPs, the measurement of the beacon made by the serving TRP, and handover threshold criteria, the TRP determines whether to handover the UE to one of the target TRPs and to which of the target TRPs to handover the UE if a handover is determined to be beneficial. In some embodiments, one of the target TRPs makes the determination whether to make a handover. In other embodiments, another network component that is not either the serving TRP or any of the target TRPs determines whether to handover and, if it determines to handover, which of the target TRPs to handover the UE. The TRP with the best measurement of the UEs beacon is not necessarily the TRP selected to serve the UE. Other considerations such as load balancing may be used to determine which TRP to select to serve the UE.

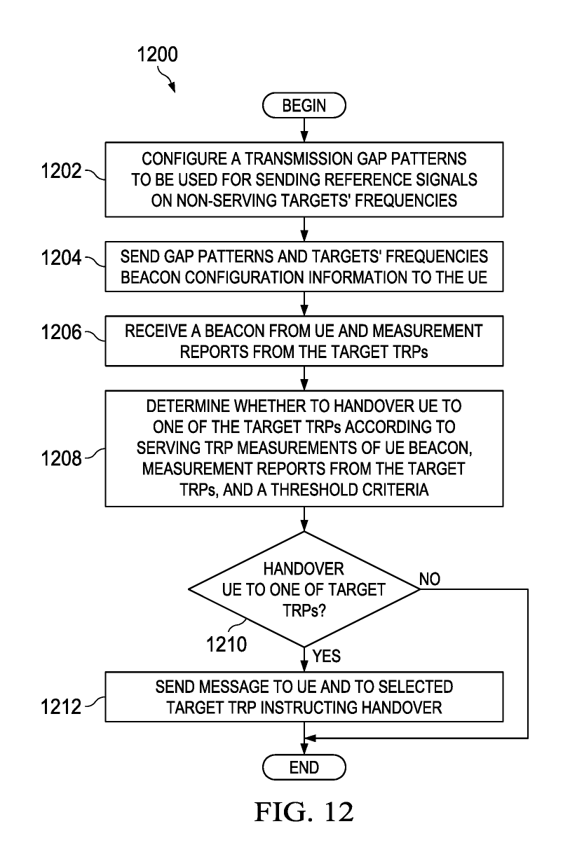

FIG. 12 is an embodiment method 1200 in a source TRP for inter-frequency mobility for selecting a target TRP from a plurality of potential target TRPs. The method 1200 begins at block 1202 where the serving TRP configures transmission gap patterns to be used for sending reference signal on non-serving target TRPs' frequencies. Each individual non-serving target TRP may have a gap pattern configured and assigned to it for purposed of the UE transmitting beacons. At block 1204, the serving TRP sends the gap patterns and target TRPs' frequencies beacon configuration information to the UE. The information includes the TRP frequency for each of the non-serving target TRPs. At block 1206, the source TRP receives a beacon from the UE and measurement reports from the target TRPs. In an embodiment, the measurement reports from each of the target TRPs is based on the beacon the each target TRP received from the UE on the respective target TRP's UL frequency during the transmission gap pattern. At block 1208, the serving TRP determines whether to handover the UE to one of the target TRPs according to the serving TRP measurement of the UE beacon, measurement reports from each (or at least two) of the target TRPs, and a threshold criteria. If a handover is recommended, the serving TRP determines which of the target TRPs should become the serving TRP according to comparisons of the measurement reports of each of the TRPs with the others and according to the threshold criteria. In an embodiment, the target TRP with the best measurement of the UEs beacon is selected. In other embodiments, the target TRP with the best measurement of the UEs beacon may not be selected due to other criteria, such as, for load balancing purposes, etc. At block 1210, the serving TRP determines whether to handover the UE to a selected on of the target TRPs and, if no handover is recommended, the method 1200 may end. If, at block 1210, the serving TRP determines that a handover to one of the target TRPs should occur, then the method 1200 proceeds to block 1212 where the serving TRP sends a message to the UE and to the selected target TRP instructing handover, after which, the method 1200 may end.

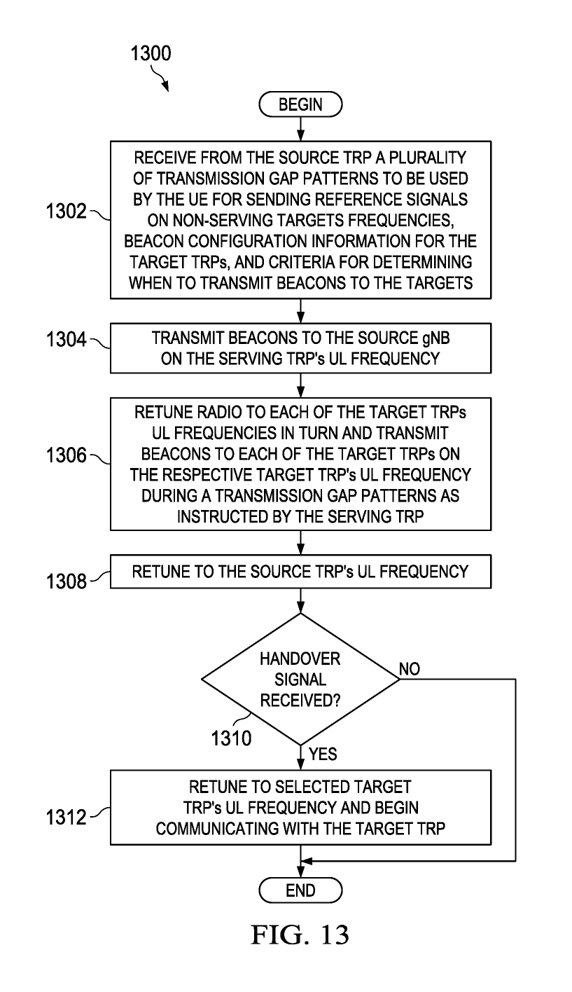

FIG. 13 is a flowchart of an embodiment method 1300 for a UE for inter-frequency mobility to select from multiple target TRPs. The method 1300 may begin at block 1302 where the UE receives from the source TRP a plurality of transmission gap patterns to be used by the UE for sending reference signals on non-serving targets frequencies, beacon configuration information for the target TRPs, and criteria for determining when to transmit beacons to the targets. At block 1304, the UE transmits a beacon to the source gNB on the serving TRP's UL frequency. At block 1306, the UE retunes its radio to that of each of the target TRPs' UL frequencies in turn and transmits beacons to each of the target TRPs on the respective target TRP's UL frequency during a transmission gap pattern as instructed by the serving TRP. AT block 1308, the UE retunes to the source TRP's UL frequency. At block 1310, the UE determines whether a handover signal has been received. If, at block 1310, no handover signal is received, the method 1300 may end. If, at block 1310, the UE receives a handover signal, the method 1300 proceeds to block 1312 where the UE retunes its radio to the selected target TRP's UL frequency and begins communicating with the selected target TRP, after which, the method 1300 may end.

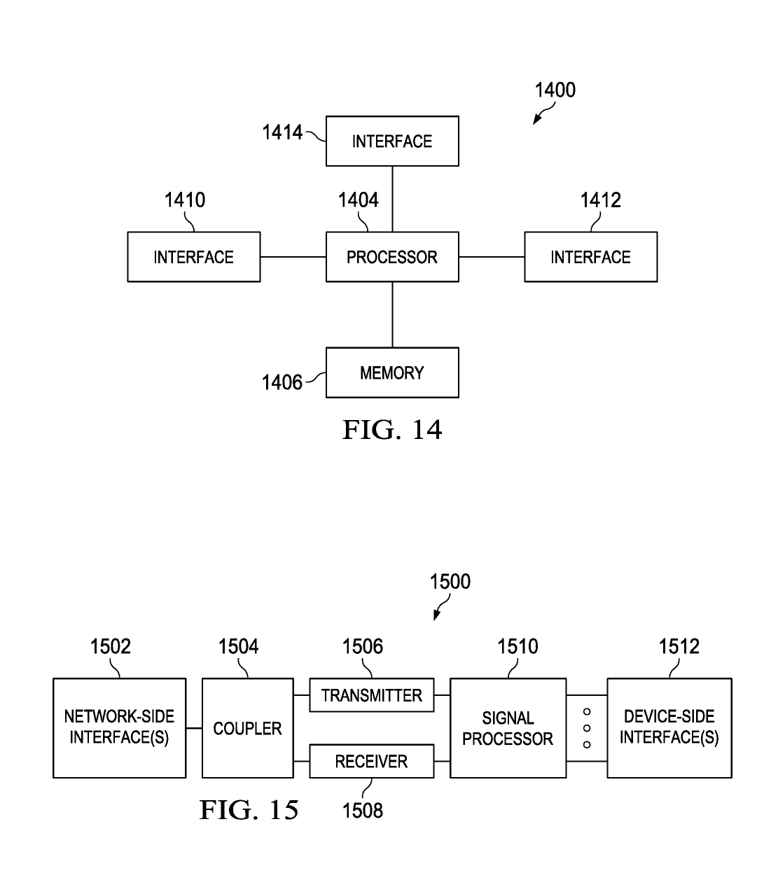

FIG. 14 illustrates a block diagram of an embodiment processing system 1400 for performing methods described herein, which may be installed in a host device. As shown, the processing system 1400 includes a processor 1404, a memory 1406, and interfaces 1410-1414, which may (or may not) be arranged as shown in FIG. 14. The processor 1404 may be any component or collection of components adapted to perform computations and/or other processing related tasks, and the memory 1406 may be any component or collection of components adapted to store programming and/or instructions for execution by the processor 1404. In an embodiment, the memory 1406 includes a non-transitory computer readable medium. The interfaces 1410, 1412, 1414 may be any component or collection of components that allow the processing system 1400 to communicate with other devices/components and/or a user. For example, one or more of the interfaces 1410, 1412, 1414 may be adapted to communicate data, control, or management messages from the processor 1404 to applications installed on the host device and/or a remote device. As another example, one or more of the interfaces 1410, 1412, 1414 may be adapted to allow a user or user device (e.g., personal computer (PC), etc.) to interact/communicate with the processing system 1400. The processing system 1400 may include additional components not depicted in FIG. 14, such as long term storage (e.g., non-volatile memory, etc.).

In some embodiments, the processing system 1400 is included in a network device that is accessing, or part otherwise of, a telecommunications network. In one example, the processing system 1400 is in a network-side device in a wireless or wireline telecommunications network, such as a base station, a relay station, a scheduler, a controller, a gateway, a router, an applications server, or any other device in the telecommunications network. In other embodiments, the processing system 1400 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1410, 1412, 1414 connects the processing system 1400 to a transceiver adapted to transmit and receive signaling over the telecommunications network. FIG. 15 illustrates a block diagram of a transceiver 1500 adapted to transmit and receive signaling over a telecommunications network. The transceiver 1500 may be installed in a host device. As shown, the transceiver 1500 includes a network-side interface 1502, a coupler 1504, a transmitter 1506, a receiver 1508, a signal processor 1510, and a device-side interface 1512. The network-side interface 1502 may include any component or collection of components adapted to transmit or receive signaling over a wireless or wireline telecommunications network. The coupler 1504 may include any component or collection of components adapted to facilitate bi-directional communication over the network-side interface 1502. The transmitter 1506 may include any component or collection of components (e.g., up-converter, power amplifier, etc.) adapted to convert a baseband signal into a modulated carrier signal suitable for transmission over the network-side interface 1502. The receiver 1508 may include any component or collection of components (e.g., down-converter, low noise amplifier, etc.) adapted to convert a carrier signal received over the network-side interface 1502 into a baseband signal. The signal processor 1510 may include any component or collection of components adapted to convert a baseband signal into a data signal suitable for communication over the device-side interface(s) 1512, or vice-versa. The device-side interface(s) 1512 may include any component or collection of components adapted to communicate data-signals between the signal processor 1510 and components within the host device (e.g., the processing system 1400, local area network (LAN) ports, etc.).

The transceiver 1500 may transmit and receive signaling over any type of communications medium. In some embodiments, the transceiver 1500 transmits and receives signaling over a wireless medium. For example, the transceiver 1500 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1502 includes one or more antenna/radiating elements. For example, the network-side interface 1502 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1500 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

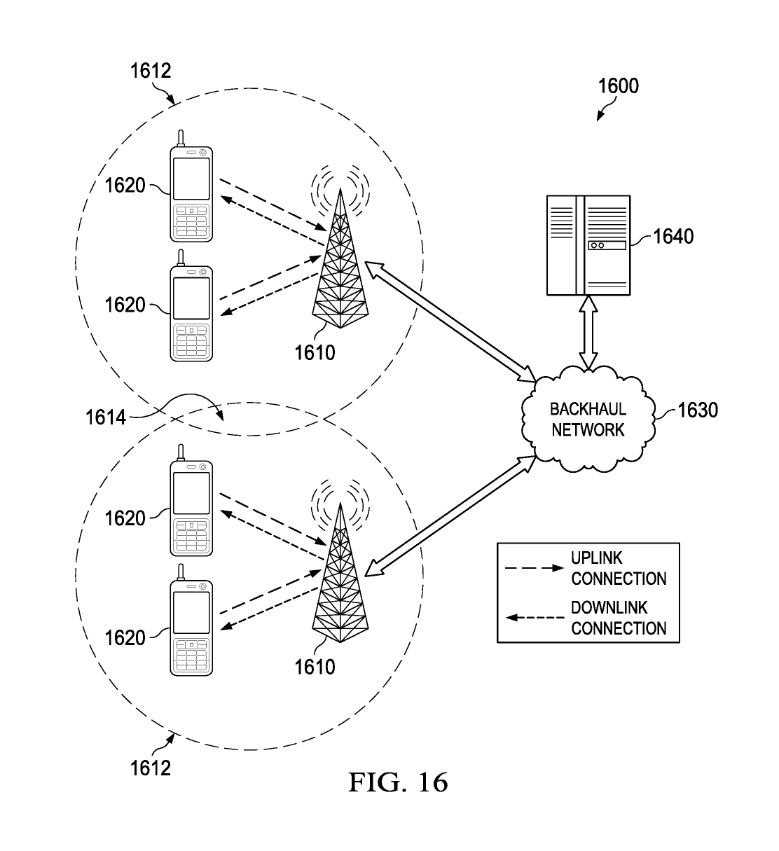

FIG. 16 illustrates a network 1600 for communicating data. The network 1600 comprises a plurality of access points (APs) 1610 each having a coverage area 1612, a plurality of user equipment (UEs) 1620, a backhaul network 1630, and a media server 1640. As used herein, the term AP may also be referred to as a transmission point (TP), a base station (BS), a base transceiver station (BTS), an eNB, or a gNB, and the terms may be used interchangeably throughout this disclosure. These coverage areas represent the range of each AP 1610 to adequately transmit data, and the coverage areas of adjacent APs 1610 may have some overlap 1614 in order to accommodate handoffs between APs 1610 whenever a UE 1620 exits one coverage area 1612 and enters an adjacent coverage area 1612. The AP 1610 may comprise any component capable of providing wireless access by, inter alia, establishing uplink (dashed line) and/or downlink (dotted line) connections with the UEs 1620, such as a base transceiver station (BTS), an enhanced base station (eNB), a femtocell, and other wirelessly enabled devices. The UEs 1620 may comprise any component capable of establishing a wireless connection with the AP 1610. For example, the UE 1620 may be a smartphone, a laptop computer, a tablet computer, a wireless telephone, etc. The UEs 1620 may also be referred to as wireless devices, mobile devices, or wireless mobile devices. The backhaul network 1630 may be any component or collection of components that allow data to be exchanged between the AP 1610 and a remote end (not shown). In some embodiments, the network 1600 may comprise various other wireless devices, such as relays, femtocells, etc.

Network 1600 is merely an example of a network in which the disclosed methods and systems may be implemented.

In an embodiment, a method in a serving transmit-receive point (TRP) for operating uplink (UL) reference signals to support inter-frequency mobility includes receiving, at the serving TRP, a first reference signal from a user equipment (UE), the first reference signal transmitted on a serving TRP UL frequency. The method also includes configuring, by the serving TRP, a transmission gap pattern to be used for sending a second reference signal on a non-serving TRP UL frequency. The non-serving TRP UL frequency is different from the serving TRP UL frequency. The transmission gap pattern represents a time interval during which the UE is not scheduled by the serving TRP UL frequency. The method also includes sending, by the serving TRP, a transmission gap pattern configuration and a second reference signal configuration to the UE.

In an embodiment, the method also includes receiving measurement information from the non-serving TRP, the measurement information determined by the non-serving TRP according to the second reference signal received by the non-serving TRP from the UE. In an embodiment, the method also includes sending a handover message to the non-serving TRP and a handover message to the UE when the serving TRP determines that threshold handover criteria have been satisfied according to the measurement information and a measurement of the first reference signal determined by the serving TRP. In an embodiment, the method includes receiving a handover message from the non-serving TRP when the non-serving TRP determines that criteria for handover of the UE from the serving TRP to the non-serving TRP have been satisfied. In an embodiment, the method also includes coordinating with the non-serving TRP to determine the second reference signal configuration. In an embodiment, the method includes sending, by the serving TRP, one or more signaling criteria for determining when to send the second reference signal to the UE.

In an embodiment, the configuring, by the serving TRP, the transmission gap pattern to be used for sending a second reference signal on a non-serving TRP UL frequency includes configuring, by the serving TRP, a plurality of gap patterns to be used for sending a plurality of second reference signals on a plurality of non-serving TRP UL frequencies. Each of the plurality of second reference signals corresponding to a respective one of a plurality of non-serving TRPs. Each of the non-serving TRP UL frequencies is different from the serving TRP UL frequency. The transmission gap patterns represent time intervals during which the UE is not scheduled by the serving TRP UL frequency.

In an embodiment, the sending further includes sending, by the serving TRP, a plurality of transmission gap pattern configurations and a plurality of second reference signal configurations to the UE.

In an embodiment, the method also includes receiving measurement information from at least two of the plurality of non-serving TRPs, the measurement information determined by each of the at least two non-serving TRPs according to the a corresponding one of the plurality of second reference signals received by each of the at least two of the plurality of non-serving TRPs from the UE. The method also includes determining a selected non-serving TRP from the at least two of the plurality of non-serving TRPs according to the threshold handover criteria. The method also includes sending a handover message to the selected non-serving TRP and a handover message to the UE when the serving TRP determines that the threshold handover criteria have been satisfied according to the measurement information and a measurement of the first reference signal determined by the serving TRP.

In an embodiment, a method in a non-serving transmit-receive point (TRP) for operating uplink (UL) reference signals to support inter-frequency mobility includes receiving, at the non-serving TRP, a transmission gap pattern from a serving TRP. The transmission gap pattern is to be used for sending a reference signal on a non-serving TRP UL frequency. The non-serving TRP UL frequency is different from a serving TRP UL frequency. The transmission gap pattern represents a time interval during which the UE is not scheduled by the serving TRP UL frequency. The method also includes receiving, at the on-serving TRP, the reference signal from the UE during the transmission gap pattern. The method also includes measuring a parameter of the reference signal, the parameter measurement used to determine whether to handover the UE from the serving TRP to the non-serving TRP.

In an embodiment, the method also includes sending a handover message to the serving TRP and a handover message to the UE when the non-serving TRP determines that criteria for handover of the UE from the serving TRP to the non-serving TRP have been satisfied according to the parameter measurement.

In an embodiment, the method also includes receiving a handover message from the serving TRP. The method also includes sending configuration information to the UE to enable to the UE to communicate with the non-serving TRP, the non-serving TRP becoming the TRP serving the UE.

In an embodiment, the method also includes coordinating with the serving TRP to determine criteria for handover of the UE from the serving TRP to the non-serving TRP.

In an embodiment, a method in a user equipment (UE) for operating uplink (UL) reference signals to support inter-frequency mobility includes transmitting, by the UE, a first reference signal on a first frequency to a serving transmit-receive point (TRP). The method includes receiving, at the UE, a transmission gap pattern configuration to be used for sending a second reference signal on a second frequency. The second frequency corresponds to a UL frequency of a non-serving TRP. The transmission gap pattern represents a set of time intervals during which the UE is not scheduled by the serving TRP. The first frequency is not equal to the second frequency. The method also includes transmitting, by the UE, the second reference signal on the second frequency to the non-serving TRP. The method also includes retuning, by the UE, a radio of the UE to the first frequency.

In an embodiment, the method also includes receiving, by the UE, second reference signal criteria from the serving TRP, the second reference signal criteria specifying conditions to be met before the UE transmits the second reference signal during the transmission gap pattern. In an embodiment, the method includes receiving, at the UE, a handover message and tuning, by the UE, a radio of the UE to the second frequency. In an embodiment, the method also includes receiving, at the UE, a handover message and performing, by the UE, a handover procedure to the second frequency.

In an embodiment, a network component for operating uplink (UL) reference signals to support inter-frequency mobility includes a processor and a computer readable storage medium storing programming for execution by the processor. The programming includes instructions for receiving a first reference signal from a user equipment (UE), the first reference signal transmitted on a serving TRP UL frequency. The programming also includes instructions for configuring a transmission gap pattern to be used for sending a second reference signal on a non-serving TRP UL frequency. The non-serving TRP UL frequency is different from the serving TRP UL frequency. The transmission gap pattern represents a set of time intervals during which the UE is not scheduled by the serving TRP UL frequency. The programming also includes instructions for sending a transmission gap pattern configuration and a second reference signal configuration to the UE.

In an embodiment, a network component for operating uplink (UL) reference signals to support inter-frequency mobility includes a processor and a computer readable storage medium storing programming for execution by the processor. The programming including instructions for receiving a transmission gap pattern from a serving transmit-receive point (TRP), the transmission gap pattern to be used for sending a reference signal to a non-serving TRP on a non-serving TRP UL frequency. The non-serving TRP UL frequency is different from a serving TRP UL frequency. The transmission gap pattern represents a set of time intervals during which the user equipment (UE) is not scheduled by the serving TRP UL frequency. The programming also includes instructions for receiving the reference signal from the UE during the transmission gap pattern. The programming also includes instructions for measuring a parameter of the reference signal, the parameter measurement used to determine whether to handover the UE from the serving TRP to the non-serving TRP.

In an embodiment, a user equipment (UE) for operating uplink (UL) reference signals to support inter-frequency mobility includes a processor and a computer readable storage medium storing programming for execution by the processor. The programming including instructions for transmitting, by the UE, a first reference signal on a first frequency to a serving transmit-receive point (TRP). The programming also includes instructions for receiving, at the UE, a transmission gap pattern configuration to be used for sending a second reference signal on a second frequency. The second frequency corresponds to an UL frequency of a non-serving TRP. The transmission gap pattern represents a set of time intervals during which the UE is not scheduled by the serving TRP. The first frequency is not equal to the second frequency. The programming also includes transmitting, by the UE, the second reference signal on the second frequency to the non-serving TRP. The programming also includes retuning, by the UE, a radio of the UE to the first frequency.

A computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a configuring unit/module, a tuning unit/module and an retuning unit/module. The respective units/modules may be hardware, software, or a combination thereof. For instance, one or more of the units/modules may be an integrated circuit, such as field programmable gate arrays (FPGAs) or application-specific integrated circuits (ASICs).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method in a serving transmit-receive point (TRP) for operating uplink (UL) reference signals to support inter-frequency mobility, comprising:
receiving, at the serving TRP, a first reference signal from a user equipment (UE), the first reference signal transmitted on a serving TRP UL frequency;
configuring, by the serving TRP, a transmission gap pattern to be used for sending a second reference signal on a non-serving TRP UL frequency, the non-serving TRP UL frequency being different from the serving TRP UL frequency, and the transmission gap pattern representing a set of time intervals during which the UE is not scheduled by the serving TRP UL frequency; and
sending, by the serving TRP, a transmission gap pattern configuration and a second reference signal configuration to the UE.

2. The method of claim 1, further comprising:
receiving measurement information from the non-serving TRP, the measurement information determined by the non-serving TRP according to the second reference signal received by the non-serving TRP from the UE; and
sending a handover message to the non-serving TRP and a handover message to the UE when the serving TRP determines that threshold handover criteria have been satisfied according to the measurement information and a measurement of the first reference signal determined by the serving TRP.

3. The method of claim 1, further comprising:
receiving a handover message from the non-serving TRP when the non-serving TRP determines that criteria for handover of the UE from the serving TRP to the non-serving TRP have been satisfied.

4. The method of claim 1, further comprising:
coordinating with the non-serving TRP to determine the second reference signal configuration.

5. The method of claim 1, further comprising:
sending, by the serving TRP to the UE, one or more signaling criteria by which the UE determines when to send the second reference signal.

6. The method of claim 1, wherein the configuring, by the serving TRP, the transmission gap pattern to be used for sending a second reference signal on a non-serving TRP UL frequency comprises configuring, by the serving TRP, a plurality of gap patterns to be used for sending a plurality of second reference signals on a plurality of non-serving TRP UL frequencies, wherein each of the plurality of second reference signals corresponding to a respective one of a plurality of non-serving TRPs, wherein each of the non-serving TRP UL frequencies is different from the serving TRP UL frequency, and where the transmission gap patterns represent time intervals during which the UE is not scheduled by the serving TRP UL frequency; and
wherein the sending further comprises sending, by the serving TRP, a plurality of transmission gap pattern configurations and a plurality of second reference signal configurations to the UE.

7. The method of claim 6, further comprising:
receiving measurement information from at least two of the plurality of non-serving TRPs, the measurement information determined by each of the at least two non-serving TRPs according to the a corresponding one of the plurality of second reference signals received by each of the at least two of the plurality of non-serving TRPs from the UE;
determining a selected non-serving TRP from the at least two of the plurality of non-serving TRPs according to threshold handover criteria; and
sending a handover message to the selected non-serving TRP and a handover message to the UE when the serving TRP determines that the threshold handover criteria have been satisfied according to the measurement information and a measurement of the first reference signal determined by the serving TRP.

8. A method in a non-serving transmit-receive point (TRP) for operating uplink (UL) reference signals to support inter-frequency mobility, comprising:
receiving, at the non-serving TRP, a transmission gap pattern from a serving TRP, the transmission gap pattern to be used for sending a reference signal on a non-serving TRP UL frequency, the non-serving TRP UL frequency being different from a serving TRP UL frequency, and the transmission gap pattern representing a set of time intervals during which the UE is not scheduled by the serving TRP UL frequency;
receiving, at the on-serving TRP, the reference signal from the UE during the transmission gap pattern; and
measuring a parameter of the reference signal, the parameter measurement used to determine whether to handover the UE from the serving TRP to the non-serving TRP.

9. The method of claim 8, further comprising:
sending a handover message to the serving TRP when the non-serving TRP determines that criteria for handover of the UE from the serving TRP to the non-serving TRP have been satisfied according to the parameter measurement.

10. The method of claim 8, further comprising:
sending a handover message to the UE when the non-serving TRP determines that criteria for handover of the UE from the serving TRP to the non-serving TRP have been satisfied according to the parameter measurement.

11. The method of claim 8, further comprising:
receiving a handover message from the serving TRP; and
sending configuration information to the UE to enable to the UE to communicate with the non-serving TRP, the non-serving TRP becoming the TRP serving the UE.

12. The method of claim 8, further comprising:
coordinating with the serving TRP to determine criteria for handover of the UE from the serving TRP to the non-serving TRP.

13. A method in a user equipment (UE) for operating uplink (UL) reference signals to support inter-frequency mobility, comprising:
transmitting, by the UE, a first reference signal on a first frequency to a serving transmit-receive point (TRP);
receiving, at the UE, a transmission gap pattern configuration to be used for sending a second reference signal on a second frequency, the second frequency corresponding to an UL frequency of a non-serving TRP, the transmission gap pattern representing a set of time intervals during which the UE is not scheduled by the serving TRP, and the first frequency not being equal to the second frequency; and
transmitting, by the UE, the second reference signal on the second frequency to the non-serving TRP.

14. The method of claim 13, further comprising:
receiving, by the UE, second reference signal criteria from the serving TRP, the second reference signal criteria specifying conditions to be met before the UE transmits the second reference signal during the transmission gap pattern.

15. The method of claim 13, further comprising:
receiving, at the UE, a handover message; and
performing, by the UE, a handover procedure to the second frequency.

16. A network component for operating uplink (UL) reference signals to support inter-frequency mobility, the network component comprising:
a memory storage comprising instructions; and
one or more processors in communication with the memory, wherein the one or more processors execute the instructions to:
receive a first reference signal from a user equipment (UE), the first reference signal transmitted on a serving TRP UL frequency;
configure a transmission gap pattern to be used for sending a second reference signal on a non-serving TRP UL frequency, the non-serving TRP UL frequency being different from the serving TRP UL frequency, and the transmission gap pattern representing a set of time intervals during which the UE is not scheduled by the serving TRP UL frequency; and
send a transmission gap pattern configuration and a second reference signal configuration to the UE.

17. The network component of claim 16, wherein the one or more processers further execute the instructions to:
receive measurement information from the non-serving TRP, the measurement information determined by the non-serving TRP according to the second reference signal received by the non-serving TRP from the UE; and
send a handover message to the non-serving TRP and a handover message to the UE when the serving TRP determines that threshold handover criteria have been satisfied according to the measurement information and a measurement of the first reference signal determined by the serving TRP.

18. The network component of claim 16, wherein the one or more processors further execute the instructions to:
receive a handover message from the non-serving TRP when the non-serving TRP determines that criteria for handover of the UE from the serving TRP to the non-serving TRP have been satisfied.

19. The network component of claim 16, wherein the one or more processors further execute the instructions to:
coordinate with the non-serving TRP to determine the second reference signal configuration.

20. The network component of claim 16, wherein the one or more processors further execute the instructions to:
send, by the serving TRP to the UE, one or more signaling criteria by which the UE determines when to send the second reference signal.

21. The network component of claim 16, wherein the instructions to configure, by the serving TRP, the transmission gap pattern to be used for sending a second reference signal on a non-serving TRP UL frequency comprises instructions to configure a plurality of gap patterns to be used for sending a plurality of second reference signals on a plurality of non-serving TRP UL frequencies, wherein each of the plurality of second reference signals corresponding to a respective one of a plurality of non-serving TRPs, wherein each of the non-serving TRP UL frequencies is different from the serving TRP UL frequency, and where the transmission gap patterns represent time intervals during which the UE is not scheduled by the serving TRP UL frequency; and
wherein the instructions to send further comprises instructions to send a plurality of transmission gap pattern configurations and a plurality of second reference signal configurations to the UE.

22. The network component of claim 21, wherein the one or more processor further execute the instructions to:
receive measurement information from at least two of the plurality of non-serving TRPs, the measurement information determined by each of the at least two non-serving TRPs according to the a corresponding one of the plurality of second reference signals received by each of the at least two of the plurality of non-serving TRPs from the UE;
determine a selected non-serving TRP from the at least two of the plurality of non-serving TRPs according to threshold handover criteria; and
send a handover message to the selected non-serving TRP and a handover message to the UE when the serving TRP determines that the threshold handover criteria have been satisfied according to the measurement information and a measurement of the first reference signal determined by the serving TRP.

23. A network component for operating uplink (UL) reference signals to support inter-frequency mobility, the network component comprising:
a memory storage comprising instructions; and
one or more processor in communication with the memory, wherein the one or more processor execute the instructions to:
receive a transmission gap pattern from a serving transmit-receive point (TRP), the transmission gap pattern to be used for sending a reference signal to a non-serving TRP on a non-serving TRP UL frequency, the non-serving TRP UL frequency being different from a serving TRP UL frequency, and the transmission gap pattern representing a set of time intervals during which the user equipment (UE) is not scheduled by the serving TRP UL frequency;
receive the reference signal from the UE during the transmission gap pattern; and
measure a parameter of the reference signal, the parameter measurement used to determine whether to handover the UE from the serving TRP to the non-serving TRP.

24. The network component of claim 23, wherein the one or more processors further execute the instructions to:
send a handover message to the serving TRP when the non-serving TRP determines that criteria for handover of the UE from the serving TRP to the non-serving TRP have been satisfied according to the parameter measurement.

25. The network component of claim 23, wherein the one or more processors further execute the instructions to:
send a handover message to the UE when the non-serving TRP determines that criteria for handover of the UE from the serving TRP to the non-serving TRP have been satisfied according to the parameter measurement.

26. The network component of claim 23, wherein the one or more processors further execute the instructions to:
receive a handover message from the serving TRP; and
send configuration information to the UE to enable to the UE to communicate with the non-serving TRP, the non-serving TRP becoming the TRP serving the UE.

27. The network component of claim 23, wherein the one or more processors further execute the instructions to:
coordinate with the serving TRP to determine criteria for handover of the UE from the serving TRP to the non-serving TRP.

28. A user equipment (UE) for operating uplink (UL) reference signals to support inter-frequency mobility, the network component comprising:
a memory storage comprising instructions; and
one or more processors in communication with the memory, wherein the one or more processor execute the instructions to:
transmit, by the UE, a first reference signal on a first frequency to a serving transmit-receive point (TRP);
receive, at the UE, a transmission gap pattern configuration to be used for sending a second reference signal on a second frequency, the second frequency corresponding to an UL frequency of a non-serving TRP, the transmission gap pattern representing a set of time intervals during which the UE is not scheduled by the serving TRP, and the first frequency not being equal to the second frequency; and
transmit, by the UE, the second reference signal on the second frequency to the non-serving TRP.

29. The UE of claim 28, wherein the one or more processors further execute the instructions to:
receive, by the UE, second reference signal criteria from the serving TRP, the second reference signal criteria specifying conditions to be met before the UE transmits the second reference signal during the transmission gap pattern.

30. The UE of claim 28, wherein the one or more processor further executes the instructions to:
receive, at the UE, a handover message; and
perform, by the UE, a handover procedure to the second frequency.
